(19) United States
(12) Patent Application Publication
(10) Pub. No.: US 2023/0149246 A1
(43) Pub. Date: May 18, 2023

(54) SMART WALKER

(71) Applicant: TAIWAN NAME PLATE CO., LTD., TAOYUAN CITY (TW)

(72) Inventors: WEN-CHENG YIN, NEW TAIPEI CITY (TW); YU-HSUN TSENG, TAOYUAN CITY (TW); KAI-LI PENG, TAOYUAN CITY (TW)

(21) Appl. No.: 17/931,420

(22) Filed: Sep. 12, 2022

(30) Foreign Application Priority Data
Nov. 12, 2021 (TW) 110213375

(51) Int. Cl. A61H 3/00

(52) U.S. Cl. CPC A61H 3/00; A61H 2201/0173; A61H 2201/0188; A61H 2201/0192; A61H 2201/1635; A61H 2201/5007; A61H 2201/5058; A61H 2201/5069; A61H 2201/5071; A61H 2201/5092

(57) ABSTRACT

The present disclosure discloses a smart walker including a walker body, a first support member, a first sensing device, a second support member and a control device. The walker body includes a fixing member. The first support member and the second support member are connected to both ends of the fixing member, and each of the support members includes a handle, a front leg, and a rear leg. The first sensing device is disposed on a central leg to sense a surrounding environment, thereby obtaining a sensing signal. The control device includes a processor connected to the first sensing device and receives the sensing signal to determine whether an obstacle is present around the smart walker by judging the image.

### CROSS-REFERENCE TO RELATED APPLICATION

This application claims priority from Taiwan Patent Application No. 110213375 filed on Nov. 12, 2021, in the Taiwan Intellectual Property Office, the content of which is hereby incorporated by reference in its entirety for all purposes.

### BACKGROUND

### Technical Field

The present disclosure relates to a smart walker, particularly to a smart walker having improved convenience and safety with smart peripheral image judgment and safety protection functions.

### Description of the Related Art

Due to various factors such as old age, injury, and post-surgery, a user may be inconvenient in movement or may be in a situation requiring rehabilitation. At this point, the user may need an auxiliary tool for assisting motions such as walking and supporting. There are many different types of auxiliary tools. Various crutches and walkers may provide corresponding supports depending on the user’s needs. For example, through handles on both sides of a walker, the user may be provided with a supporting power applied to the body by applying a power to the arm, and a forward walking action may be assisted to restore or train lower body strength, so as to achieve the purpose of rehabilitation.

However, when the walker is used, the users may experience various physically discomforting situations. When there is no one around to take care of the user and when the user loses balance and falls down, it is often difficult to erect him/herself or stand up again without assistance, and accordingly, there are still doubts about the safety in use. In addition, most of the users are elderly and have perception and reaction abilities inferior to those of ordinary people, and it is difficult to immediately respond to changes in the surrounding environment. When the walker is used, the user may tripped while the walker is blocked or obstructed by a table or chair. The older people tend to be injured more seriously. With respect to the above problem, it may be another solution to select another auxiliary tool, in addition to increasing the assistance of a caregiver. The user may select the appropriate type of auxiliary tool. However, when the auxiliary tool provides an assistive function as well as the balance-supporting function, it may be helpful in solving the safety concerns that may occur when the conventional walker is used.

In conclusion, the conventional walkers still have significant problems in terms of safety in use and immediacy in care. Accordingly, the present disclosure has designed a smart walker in consideration of the above problems, in particular, improved the defects in the related art, and increased the industrial applicability.

### SUMMARY

In view of the conventional problems described above, an object of the present disclosure is to provide a smart walker to solve the problems in safety and care of the conventional walkers.

One purpose of the present disclosure proposes a smart walker including a walker body, a first sensing device, a first support member, a second support member, and a control device. Wherein, the walker body includes a fixing member and a central leg, and the central leg is connected to a central position of the fixing member. The first sensing device is disposed on a central leg for obtaining a first sensing signal by sensing a surrounding environment. The first support member is connected to one end of the fixing member and the first support member includes a first handle, a first front leg and a first rear leg. Both ends of the first handle are connected to the first front leg and the first rear leg, respectively. The second support member is connected to an opposite end of the fixing member and the second support member includes a second handle, a second front leg and a second rear leg. Both ends of the second handle are connected to the second front leg and the second rear leg, respectively. The control device includes a processor and is connected to the first sensing device to receive the first sensing signal. The processor reads and determines whether an obstacle is present around the smart walker.

Preferably, each of the first front leg, the first rear leg, the second front leg and the second rear leg may include a stop device. When the control device determines that the obstacle is present therearound, each of the stop devices descends to allow each of the stop devices to contact with the ground and to fix the smart walker.

Preferably, the first support member or the second support member may include a manual switch connected to each of the stop devices to control on or off of each of the stop devices.

Preferably, each of the first front leg, the first rear leg, the second front leg and the second rear leg may include a slip-prevention member.

Preferably, the smart walker may further include a second sensing device disposed on the first front leg or the second front leg, the sensing device senses the surrounding environment to obtain a second sensing signal. The control device connects to the second sensing device to receive the first sensing signal and the second sensing signal, thereby determines whether the obstacle is present therearound.

Preferably, the first sensing device and the second sensing device may include an image capture device, a radar sensing device, an infrared sensing device, or a combination thereof.

Preferably, each of the first handle and the second handle may include a pressure sensor connected to the control device. The pressure sensors detect a using state of a user.

Preferably, a lighting device may be disposed at one end of the fixing member facing a traveling direction and is connected to the control device. The control device controls an on-off state of the lighting device according to the using state and an image reading result.

Preferably, the control device may include a storage device and the storage device is connected to the pressure sensor to record a using state.

Preferably, the fixing device may include a gyroscope connected to the control device and an inclined state of the smart walker is detected by the gyroscope.

Preferably, the control device may include a storage device and an alarm device, and the storage device connects to the gyroscope to record the inclined state. The control device generates an alarm signal from the alarm device when the inclined state is abnormal.

Preferably, the first support member and the second support member may respectively include a height adjustment rod and height levels of the first handle and the second handle are adjusted by the height adjustment rods.

Preferably, connection part between the fixing member and the first support member and connection part between the fixing part and the second support member respectively dispose a rotating member, and the rotating members enable the first support member and the second support member to be rotated toward the fixing member to a storage position.

Preferably, the walker body, the first support member and the second support member may be formed of an aluminum alloy.

Preferably, the first handle and the second handle may be formed of a soft plastic.

As mentioned previously, the smart walker in accordance with the present disclosure may have one or more advantages as follows.:
(1) The smart walker of the present disclosure may obtain sensing signals of the peripheral environments by the sensing device, identify types of objects present in the peripheral environments by using artificial intelligence, and analyze whether the obstacle is present ahead in the travel direction to actively activate a stop function, thereby preventing the user from colliding or tripping over the obstacle, so as to improve the safety in use.
(2) The smart walker according to the present disclosure may detect the using state of the user through the sensing device, a lighting assist function is provided through the control device, the alarm device transmit an alarm signal when an abnormality occurs in the using state to assist the user in trouble, so as to improve the care function of the device.
(3) The smart walker according to the present disclosure may record information such as surrounding image state and using state, provide the user with personal care records, and monitor a rehabilitation process, so that the quality of rehabilitation treatment can be improved.
(4) The smart walker according to the present disclosure may dispose the height adjustment rods and the rotating members, and select the lightweight materials, so as to provide the user with a convenient and comfortable experience, and to improve the practicability of the device.

### BRIEF DESCRIPTION OF THE DRAWINGS

In order to facilitate understanding of the technical features, contents, advantages, and effects to be achieved of the present disclosure, the present disclosure will be described in more details hereinafter with reference to the accompanying drawings that show various embodiments of the invention as follows.

FIG. 1 is a schematic diagram of the smart walker in accordance with the embodiment of the present disclosure.

FIG. 2 is a schematic diagram of the stop device of the smart walker at on-state in accordance with the embodiment of the present disclosure.

FIG. 3 is a plan view of the smart walker in accordance with the embodiment of the present disclosure.

FIG. 4 is a schematic diagram of the height adjustment of the smart walker in accordance with the embodiment of the present disclosure.

FIG. 5 is a schematic diagram of the storage state of the smart walker in accordance with the embodiment of the present disclosure.

### DESCRIPTION OF THE PREFERRED EMBODIMENTS

In order to facilitate understanding of the features, the contents and the advantages of the present disclosure, and the effects thereof that can be achieved, the present disclosure will be described in detail bellow with reference to the accompanying drawings. The diagrams used herein are merely intended to be schematic and auxiliary to the specification, but are not necessary to be true scale and precise to the configuration after implementing the present disclosure. Thus, it should not be interpreted in accordance with the scale and the configuration of the accompanying drawings to limit the scope of the present disclosure on the practical implementation.

Throughout the specification, the same reference numeral refers to the same element. It is noted that the terms “first,” “second,” and “third” may be used herein to describe various elements, components, regions, layers and/or sections, however, these are used to distinguish one element, component, region, layer and/or section from another element, component, region, layer and/or section. Accordingly, those are used for illustrative purposes only, and it will not be construed as indicating or implying relative importance or ordinal relationship thereof.

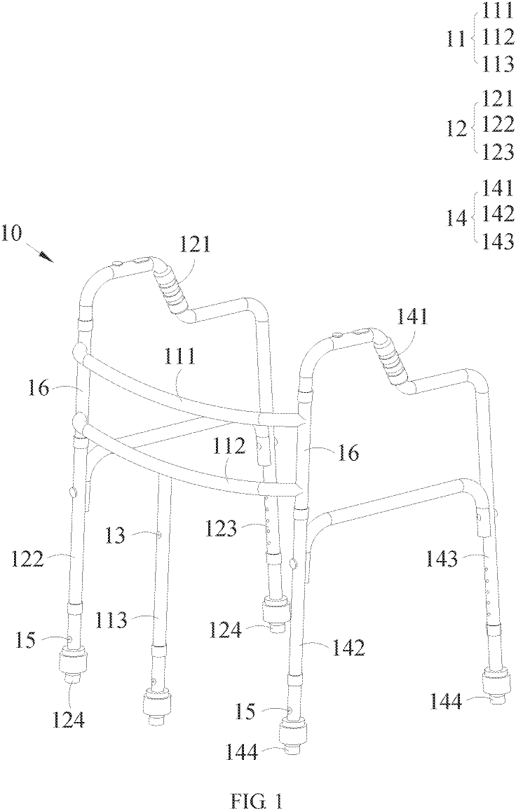

Please refer to FIG. 1, which is a schematic diagram of the smart walker in accordance with the embodiment of the present disclosure. As shown in the drawing, the smart walker 10 includes a walker body 11, a first support member 12, a first sensing device 13, a second support member 14, a second sensing device 15, and a control device 16. The walker body 11 includes a fixing member. In the embodiment, the fixing member may be provided with two horizontal bars including a first fixing member 111 and a second fixing member 112, and may be designed in the shape of a front convex arc, and the used material may include an aluminum alloy for reducing the weight of the fixing member. The fixing member may have a rod-shaped or strip-shaped outer shape, and the number of fixing members may be adjusted according to the size of the smart walker 10 and is not limited to the quantity mentioned in the present embodiment. The walker body 11 further includes a central leg 113, in which the central leg 113 may be connected to a central position of the second fixing member 112, and the material may be the same as that of the first fixing member 111 and the second fixing member 112. The first sensing device 13 is disposed on the central leg 113, in which the first sensing device 13 may include an image capture device such as a video camera, an image camera, or an lens of the image capture device, or a radar sensing device or infrared sensing device, so that a first sensing signal is obtained by sensing the surrounding environment of the smart walker 10. In the present embodiment, the first sensing device 13 may be provided by combining an image capture device for determining the environment at long distance range and a sensing radar for determining the environment at close range, so that the state of the surrounding environment is determined by the two types of sensing devices. However, the present disclosure is not limited thereto, and the number and type of the first sensing devices 13 may be adjusted as necessary.

The first support member 12 includes a first handle 121, a first front leg 122 and a first rear leg 123, and can be connected with a tube body formed of an aluminum alloy. Both ends of the first handle 121 are connected to the first front leg 122 and the first rear leg 123, respectively. The first handle 121 may have a two-stepped design with a higher front and a lower back, and is covered with a soft plastic such as PVC material. The two-stepped design of the slightly inclined handle gives the user more stability when the user grips the auxiliary device so as to prevent the hands from easily slipping or loosening. In addition, the elderly or patients who do not have strength in the hands and feet may support both wrists by dispersing the action force thereto. Each of the first front leg 122 and the first rear leg 123 includes a slip-prevention member 124. The slip-prevention member 124 may be a leg cover formed of a plastic or rubber, and the cover is disposed on the ends of the first front leg 122 and the first rear leg 123 to increase the friction force between the legs and the ground, so that the stability of the smart walker 10 is improved. A support rod may be disposed between the first front leg 122 and the first rear leg 123 to increase the overall strength of the first support member 12. The first supporting member 12 is connected to the fixing member. In the embodiment, the first front leg 122 is connected to the first fixing member 111 and the second fixing member 112. In order to assist the determination about the surrounding environment, a second sensing device 15 may be further installed at a position close to the ground of the first front leg 122, and a second sensing signal is obtained by sensing the surrounding environment of the smart walker 10 by using the video camera, image camera or image capture lens or the radar sensing device.

The second support member 14 is connected to an opposite end of the fixing member to correspond to the first support member 12. The second support member 14 includes a second handle 141, a second front leg 142, and a second rear leg 143. Similar to the first support member, both ends of the second handle 141 are connected to the second front leg 142 and the second rear leg 143, respectively. The second handle 141 may have a two-stepped design with a higher front and a lower back, and is covered with a soft plastic such as PVC material. The two-stepped design of the slightly inclined handle gives the user more stability when the user grips the auxiliary device so as to prevent the hands from easily slipping or loosening. In addition, the elderly or patients who do not have strength in the hands and feet may support both wrists by dispersing the action force thereto. Each of the second front leg 142 and the second rear leg 143 includes a slip-prevention member 144. The slip-prevention member 144 may be a leg cover formed of a plastic or rubber, and the cover is disposed on the ends of the second front leg 142 and the second rear leg 143 to increase the friction force between the legs and the ground, so that the stability of the smart walker 10 is improved. A support rod may be disposed between the second front leg 142 and the second rear leg 143 to increase the overall strength of the second support member 14. In the present embodiment, the second front leg 142 is connected to opposite ends of the first fixing member 111 and the second fixing member 112. Likewise, a second sensing device 15 may be installed on the second front leg 142, and positioned in a part close to the ground of the second front leg 142. A second sensing signal is obtained by sensing the surrounding environment of the smart walker 10 by using the video camera, image camera or image capture lens or the radar sensing device.

Since all of the walker body 11, the first support member 12 and the second support member 14 may be hollow tubular members, the control device 16 may be disposed in the accommodation space inside the tubular members. For example, may be disposed inside the first front leg 122 or the second front leg 142. In another embodiment, the control device 16 may be disposed inside the first fixing member 111 or the second fixing member 112. The control device 16 may include a processor, which may be a micro controller, a control chip with a control circuit, or a combination thereof. Through the space inside the tubular member, the control device 16 may be connected to the first sensing device 13 and the second sensing device 15, so as to receive the first sensing signal and the second sensing signal. The sensing signal (for example, image data) is computed by the processor, to judge an image type or object type, and further determine whether an obstacle is present around the smart walker 10. The control device 16 may include a memory device to store an operation program. The processor obtains the image data and then executes the instructions to access the operation program in the memory device, and analyze the content of the image through the artificial intelligence operation process like the neural network algorithm or the deep learning algorithm. For example, image features may be extracted to determine, through feature analysis, whether the object in the image belongs to the category of dangerous objects, for example, items such as slippers, bottles and cans, that are easy to trip over, or determine whether the object belongs to an obstacle such as tables or chairs. In addition, it is determined whether to give a notification to the user or to immediately lock the smart walker 10 to prevent the user from moving forward. The stop device for locking the smart walker 10 will be described in the following embodiments.

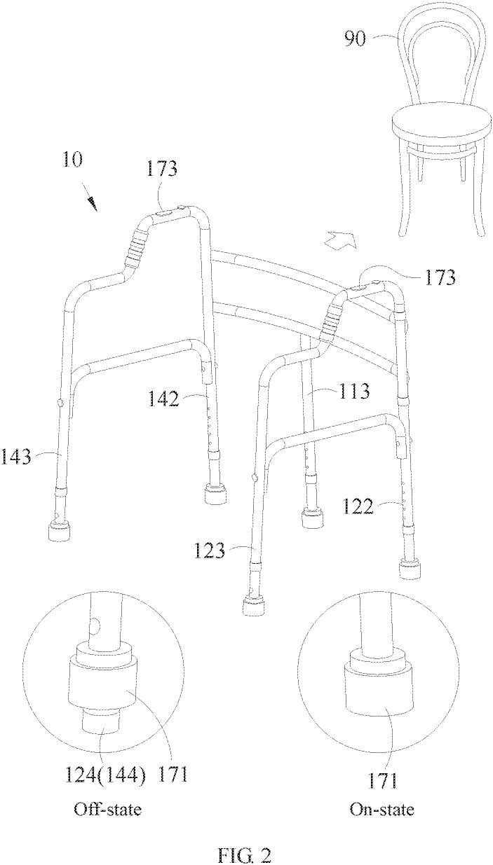

Please refer to FIG. 2, which is a schematic diagram of the stop device of the smart walker in accordance with the embodiment of the present disclosure. Please refer to FIG. 1 together, FIG. 1 shows a state in which the stop device is at off state, and FIG. 2 shows a state in which the stop device is at on state. The same reference numbers as in the previous embodiment refer to the same elements, and the same description will not be repeated. As shown in the drawings, each of the first front leg 122, the first rear leg 123, the second front leg 142, and the second rear leg 143 may include a stop device 171. The stop device 171 may include a brake member, such as a gas valve, a resistance member or brake part, and a movable covering kit, which is a member coaxial with the first front leg 122, the first rear leg 123, the second front leg 142, and the second rear leg 143, or complementarily supported with an adjacent member. When the stop device 171 is in a raised state upon being turned off, in which the slip-prevention member 124 or 144 at the bottom of each leg is exposed. At this timing, the smart walker 10 comes into contact with the ground only by the slip-prevention member 124 or 144. When the control device 16 determines that an obstacle 90 is present in the moving direction of the smart walker 10, the stop device 171 is turned on and switched into a lowered state, so that the stop device 171 and the slip-prevention member 124 or 144 at the bottom of each leg simultaneously come into contact with the ground. In addition, air inside the stop device 171 may be discharged through an air valve, so that the stop device 171 comes into close contact with the ground due to the pressure difference. Accordingly, when the user moves forward, the stop device 171 is fixed, thereby stopping the user’s action to continue moving forward, so that the user is prevented from tripping over by the obstacle 90.

In the present embodiment, the first rear leg 123 of the first support member 12 or the second rear leg 143 of the second support member 14 may include a manual switch 173, disposed near upper end of the first handle 121 or the second handle 141. The user may push the manual switch 173 to control to open or close the air valve of each stop device 171, thereby changing the rise or fall state of the stop device 171. This may be used to fix the smart walker 10 upon stopping the forward walking, or release the fixed state upon preparing for the forward walking.

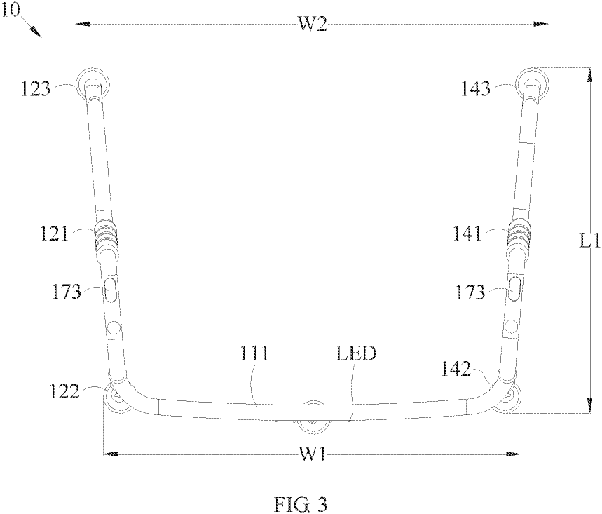

Please refer to FIG. 3, which is a plan view of the smart walker in accordance with the embodiment of the present disclosure. Please refer to FIG. 1 together, the same reference numbers as in the previous embodiment refer to the same elements, and the same description will not be repeated. As shown in the drawings, the smart walker 10 is provided with a first support member 12 and a second support member 14 on the left and right sides of the fixing member. The first support member 12 includes a first handle 121, a first front leg 122 and a first rear leg 123, and the second support member 14 includes a second handle 141, a second front leg 142, and a second rear leg 143. A first width W1 between the first front leg 122 and the second front leg 142 is smaller than a second width W2 between the first rear leg 123 and the second rear leg 143. The width range of the first width W1 outside the walker structure may be about 55 cm to about 61 cm, and the width range of a user activity space inside the walker may be about 48 cm to about 54 cm. The width range of the second width W2 outside the walker structure may be about 63 cm to about 69 cm, and the width range of a user activity space inside the walker may be about 56 cm to about 62 cm. For example, the first width W1 may be 51 cm inside/ 58 cm outside, and the second width W2 may be 59 cm inside/56 cm outside. In a gap width L1 between the front leg and the rear leg, an outer range may be about 45 cm to about 51 cm, and an inner range may be about 38 cm to about 44 cm. For example, the gap width L1 may be 41 cm inside / 48 cm outside.

A pressure sensor may be disposed at each position of the first handle 121 and the second handle 141, and connected to the control device 16. The pressure sensor measures the magnitude of a grip force when the user grips the handle, so that the user’s using state may be detected. For example, when the pressure sensor continuously detects changes in pressure, the control device may determine that the user is using the smart walker 10. When the pressure is not detected for a predetermined period of time, the smart walker 10 may be determined as an idle state. The user’s using state may be stored in the storage device, in which the time the user has used the smart walker 10 is recorded. In another embodiment, a moving distance of the user may be sensed in combination with a distance sensor. The walker is used because the user is unable to walk normally. Thus, the user’s exercise or rehabilitation situation may be recorded by recording the using time or walking distance, so that the user’s health status can be effectively monitored.

In addition, a lighting device LED may be disposed at one end of the first fixing member 111 or the second fixing member 112 of the fixing member facing the traveling direction. The lighting device may be one or more light emitting diode lamps. When the user’s using state is recorded in the storage device, the control unit may be set up as follows. For example, the time of use or the peripheral condition after judging the image, can be used to turn on the lighting device LED. The user may illuminate through the lighting device LED at night or in dark places, so as to provide a safe space for moving forward.

In addition to the pressure sensor, the smart walker 10 may further include a gyroscope. For example, the gyroscope is disposed in the control device or the fixing member, and the gyroscope may sense the inclined state of the smart walker. When the gyroscope senses the change in the inclined state due to the inclination of the walker, the control device may determine that the user is falling down, an alarm signal can be transmitted by the alarm device, and a relevant person can be notified for rescue assistance. The alarm signal may include an alarm sound or alarm light. Alternatively, the control device may send an alert message to a caregiver to check the user’s status.

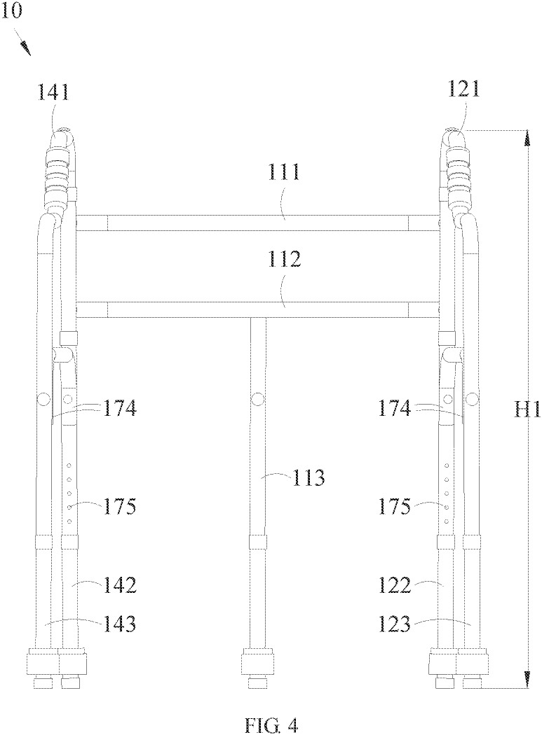

Please refer to FIG. 4, which is a schematic diagram of the height adjustment of the smart walker in accordance with the embodiment of the present disclosure. Please refer to FIG. 1 together, the same reference numbers as in the previous embodiment refer to the same elements, and the same description will not be repeated. As shown in the drawings, in the first support member 12 and the second support member 14 of the smart walker 10, each of the first front leg 122, the first rear leg 123, the second front leg 142, and the second rear leg 143 may include a height adjustment rod 174. The height adjustment rod 174 includes sleeve tubular members and a plurality of fixing holes 175. The inner and outer tubular members are fixed by the fixing hole 175, and then the position of the tubular member is fixed. In addition, height levels of the first handle 121 and the second handle 141 are adjusted. In other words, the height H1 of the smart walker 10 is adjusted. For example, the height H1 of the smart walker 10 may be in a range of about 72 cm to about 82 cm. The number of the adjusted levels may be determined through the number of fixing holes 175. In the embodiment, the height adjustment rod 174 has a height adjustment function with five levels In the present embodiment, the positions of the height adjustment rod 174 and the fixing hole 175 are manually adjustable, and the present disclosure is not limited thereto. In another embodiment, the first handle 121 and the second handle 141 may dispose an automatic height adjustment device. When a button is pressed, the adjustment rod is released and is adjusted to a hole position at a desired height.

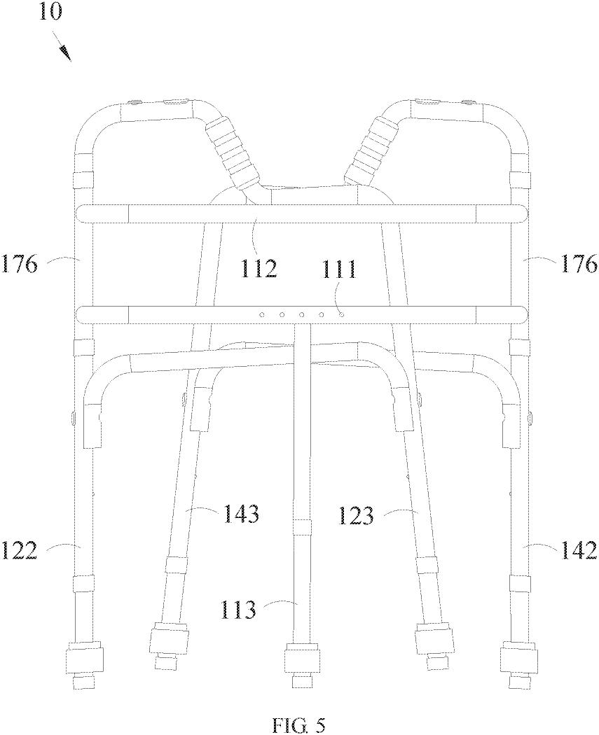

Please refer to FIG. 5, which is a schematic diagram of the storage state of the smart walker in accordance with the embodiment of the present disclosure. Please refer to FIG. 1 together, the same reference numbers as in the previous embodiment refer to the same elements, and the same description will not be repeated. As shown in the drawings, the first support member 12 and the second support member 14 of the smart walker 10 are connected to both ends of the first fixing member 111 and the second fixing member 112. The rotation members 176 are disposed at the connection part between the first front leg 122 and the first fixing member 111 and the second fixing member 112, and at the connection part between the second front leg 142 and the second front leg 142 and the first fixing member 111 and the second fixing member 112, respectively. The first support member 12 and the second support member 14 may be rotated using the first front leg 122 and the second front leg 142 as rotation axes, respectively. When the smart walker 10 is not used, the first rear leg 123 and the second rear leg 143 may be rotated toward the fixing member through the rotating members 176, so that the first support member 12 and the second support member 14 are rotated toward the storage position. When the gap width L1 is reduced, the volume required for storing the smart walker 10 is reduced, so that the storage space may be increased.

The above description is only for illustrative purpose and is not restrictive. All modifications and changes without departing from the idea of the present disclosure are included in the claims appended hereto.

What is claimed is:

1. A smart walker comprising:
a walker body comprising a fixing member and a central leg, the central leg being connected to a central position of the fixing member;
a first sensing device disposed on the central leg for obtaining a first sensing signal by sensing a surrounding environment;
a first support member connected to one end of the fixing member and the first support member comprising a first handle, a first front leg and a first rear leg, both ends of the first handle being connected to the first front leg and the first rear leg respectively;
a second support member connected to an opposite end of the fixing member and the second support member comprising a second handle, a second front leg and a second rear leg, both ends of the second handle being connected to the first front leg and the first rear leg respectively; and
a control device comprising a processor and being connected to the first sensing device to receive the first sensing signal, the processor reading the first signal and determining whether an obstacle is present around the smart walker.

2. The smart walker of claim 1, wherein each of the first front leg, the first rear leg, the second front leg and the second rear leg comprises a stop device, when the control device determines that the obstacle is present therearound, each of the stop devices descends to allow each of the stop devices to contact with a ground and to fix the smart walker.

3. The smart walker of claim 2, wherein the first support member or the second support member comprises a manual switch connected to each of the stop devices to control on or off of each of the stop devices.

4. The smart walker of claim 1, wherein each of the first front leg, the first rear leg, the second front leg and the second rear leg comprises a slip-prevention member.

5. The smart walker of claim 1, further comprising a second sensing device disposed on the first front leg or the second front leg, the second sensing device sensing the surrounding environment to obtain a second sensing signal, wherein the control device connects to the second sensing device to receive the first sensing signal and the second sensing signal, thereby determining whether the obstacle is present therearound.

6. The smart walker of claim 5, wherein the first sensing device and the second sensing device comprise an image capture device, a radar sensing device, an infrared sensing device, or a combination thereof.

7. The smart walker of claim 2, wherein each of the first handle and the second handle comprises a pressure sensor connected to the control device, the pressure sensors detect a using state of a user.

8. The smart walker of claim 7, wherein a lighting device is disposed at one end of the fixing member facing a traveling direction and is connected to the control device, the control device controls an on-off state of the lighting device according to the using state and an image reading result.

9. The smart walker of claim 7, wherein the control device comprises a storage device and the storage device is connected to the pressure sensor to record the using state.

10. The smart walker of claim 1, wherein the fixing member comprises a gyroscope connected to the control device and an inclined state of the smart walker is detected by the gyroscope.

11. The smart walker of claim 10, wherein the control device comprises a storage device and an alarm device, the storage device connects to the gyroscope to record the inclined state, and the control device generates an alarm signal from the alarm device when the inclined state is abnormal.

12. The smart walker of claim 1, wherein the first support member and the second support member respectively comprise a height adjustment rod and height levels of the first handle and the second handle are adjusted by the height adjustment rods.

13. The smart walker of claim 1, wherein connection part between the fixing member and the first support member and connection part between the fixing part and the second support member respectively dispose a rotating member, the rotating members enable the first support member and the second support member to be rotated toward the fixing member to a storage position.

14. The smart walker of claim 1, wherein the walker body, the first support member and the second support member are formed of an aluminum alloy.

15. The smart walker of claim 1, wherein the first handle and the second handle are formed of a soft plastic.
